(19) United States
(12) Patent Application Publication
(10) Pub. No.: US 2009/0041286 A1
(43) Pub. Date: Feb. 12, 2009

(54) "Isobuds" is a pair of earbud attachments

(76) Inventor: Robert Lee Wage, JR., Jackson, TN (US)

Correspondence Address: Robert Wage, 25 Richstone Cove, Jackson, TN, 38305-1716, US

(21) Appl. No.: 12/118,654

(22) Filed: May 9, 2008

Related U.S. Application Data
(60) Provisional application No. 60/963,817, filed on Aug. 8, 2007.

(51) Int. Cl. H04R 25/00

(52) U.S. Cl. 381/380

(57) ABSTRACT

The attachment is a single piece of injection molded PVC vinyl, soft plastic or other suitable material and is shaped similar to a funnel with ridges. The attachment is designed to fit the first generation ear bud that is still the most common type of ear bud. The attachment has a tunnel running through the middle of it so that music or media is transferred from the ear bud to the listener's ear. The larger section of the attachment fits completely around the “output” end of the ear bud. The larger section of the attachment is the receiving end or sound input end. The smaller section of the attachment fits into the outside edge of user's ear canal. This is called the output end because this is where the music or media exits the attachment. The middle section of the attachment is the transition area that bridges the larger section to the smaller section and provides stability for the entire unit. Standard ear buds are bulbous in shape and have a stem attached to the sphere, and are used to listen to a compact CD player, mp3 player, transistor radio or cell phone. The gradual transition from large to small or funnel or wedge shape allows isobuds to fit small, medium or large ear canals. The attachment allows for a snug compression fit in the listener's ear.

### FIELD OF THE INVENTION

The present invention relates to the most common type of ear bud. The said ear buds are used to listen to music or media from mp3s players, CD players, personal radios and cell phones. Ear buds are small speakers that are inserted into the bowl of the ear so that sound is directed into the ear of the user and the user is the only one who can hear the sound. The present invention, an attachment improves the overall performance of the ear bud. The said ear bud attachment helps facilitate the sound from the speaker to be directed into the listener's ear. The attachment is made from material that is soft enough to add comfort, yet strong enough to grip the said ear bud and hold the device stable in the listener's ear.

### BACKGROUND OF THE INVENTION

Ear bud earphones, are commonly used to listen to radios, recorded music players, mp3's, cell phones, CD players, i.e. media players. An ear bud is inserted into the bowl of the ear so that only the wearer of the ear bud can hear sound transmitted through this small electronic device. Ear buds are commonly sized from 14 mm to 17 mm in diameter as shown in figure (FIG.) 1. They are bulbous or spherical in form, made of hard plastic, and can be uncomfortable to wear. Because of their perfectly round shape, and not customized to fit any particular ear, ear buds commonly do not fit particularly well. Said differently, the contours of the ear do not match well with the hard plastic ear bud, i.e. limited contact area. With the limited contact area inside the user's ear the ear buds are difficult to keep in place, especially when the user engages in physical activity. Further limited contact area causes stress points which increases discomfort. The current invention helps the perfectly round ear bud contour to the out side edge of the ear canal, for a better fit which helps ear buds stay in place. Standard ear buds get contaminated with sweat, ear wax (cerumen), and other contaminants. Salt from sweat over a period of time deteriorates the micro electronics contained inside the ear bud which leads to distortion of the music or media being played by the media player. The user of said ear buds and media players often engage in physical activity, such as running, walking, while wearing them, and the life span of ear buds can be shortened. The volume of the media must be turn up while using standard ear buds because background noise is not blocked. The user must simply try to drown out background noise, by increasing the volume. Because of the snug fit, the present invention helps block back ground noise. The present invention applies to the most common type of ear buds, not the type mentioned in the next paragraph.

Some ear buds are designed with silicone sleeves that fit over the outer hard shell, but the silicone breaks down when it is exposed to cleansers and/or body oils. When silicone breaks down, it becomes jelly like and sticky. A small number of other ear buds are specifically designed to host an attachment specific to that ear bud. They are not a universal design and are not interchangeable with other ear buds. The current invention does not apply to the type of ear buds mentioned in this paragraph.

### BRIEF SUMMARY OF THE INVENTION

The present invention provides for an ear bud attachment that affords the listener many improvements over standard ear buds alone. The attachment helps the listener; get a more comfortable fit, a fit that helps the ear bud stay in place, an ear bud that doesn't have to be turned up so loud, an ear piece that can be kept clean without damaging the ear bud, protects the ear bud, and an attachment that can be used on many brands of ear buds. The attachment is called an isoBud, which has a universal design to fit standard ear buds that range in size from 14 mm to 17 mm in diameter. The attachment will also work with ear buds that are not perfectly round. The attachment improves the overall performance of the ear bud by; adding comfort to the listener, adding stability inside the ear, increased protection to both the outside of the ear bud speaker and the micro electronics contained inside the ear bud, and by blocking background noise. One such improvement is that the attachment is made of soft PVC vinyl and adds a cushion or padding to the outer shell of the ear bud, which improves comfort to the user. The attachment increases the contact area to both the bowl of the ear and to the outside edge of the ear canal which increases stability that allows the ear bud to stay in place during physical activities. Keeping the ear bud stable or snug in the ear reduces stress to the former limited contact area (without the attachment), which keeps the listener from having to adjust the ear buds during activity. Because of the snug fit in the user's ear, the attachment helps block background noise. Before the attachment, the only way to block out background noise was by turning up the volume and drowning out the noise. The attachment is easily removed for sterilization. Without the attachment, caution must be used when cleaning the ear bud, as moisture can damage the electronics inside the ear bud. Since the attachment is made primarily of PVC vinyl, not silicone, it can be sterilized with alcohol or soap. Cleaning solvents and body oils do not deteriorate the attachment. The attachment offer ear buds protection from wear and tear and prolong their useful life. The material properties in attachment make them durable enough to withstand the rigors of physical activity such as running, lifting weights, bicycling and other sports many people enjoy while listening to media. The attachment is designed to fit almost all standard ear buds which are 14 mm, 15 mm, 16 mm, or 17 mm and spherical in shape. The shape, size and flexibility i.e. design, of the attachment gives it a universal adaptability to fit any of the sizes and/or spherical shapes mentioned above.

### BRIEF DESCRIPTION OF DRAWINGS

The present invention will be further described with references to the accompanying drawings and where reference numerals refer to certain parts of the drawings and wherein:

FIG. 1 is a side view of a standard ear bud.

FIG. (1a) is a three dimensional view of a standard ear bud. Referring to FIGS. 1 and 2 where section 2.1 fits completely over section 1.1.

FIG. 2 is a three dimensional view the attachment. Section 2.2 is the mid section of the attachment. This area is designed to transition from larger section 2.1 to smaller section 2.3.

FIG. 2, section 2.3 is the smallest portion of the attachment. This is the part of the attachment that goes into the listener's ear. This is the out-put end of the attachment and directs the sound into the ear.

FIG. 2a is a side view of the attachment.

FIG. 3 is a side view of the attachment and illustrates the overall length of the attachment to be approximately 2 cm. FIG. 3 the side view with identifying marks, further illustrates the seat 3.4 which is the point where the ear bud face stops an rests against the seat.

FIG. 4 is a cut away view of FIG. 2 which illustrates the inside contours of the attachment and the channel running through of the attachment. Section 4.4 is the exit tunnel as sound passes from point A to point B.

FIG. (4a) is a cutaway view of the attachment which details the thickness of each section.

FIG. 5 illustrates an assembly of an ear bud and the attachment.

FIG. 6 illustrates the attachment together with the standard ear bud. When the two are connected they operate as one single unit.

FIG. 7 is a side view of the attachment and gives the dimensions of each outside section.

### DETAILED DESCRIPTION OF THE INVENTION

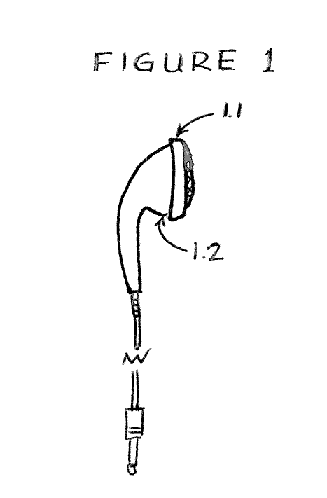

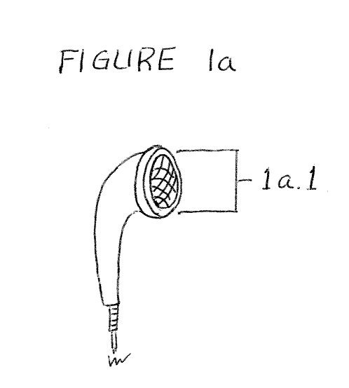

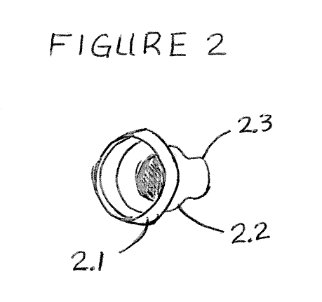

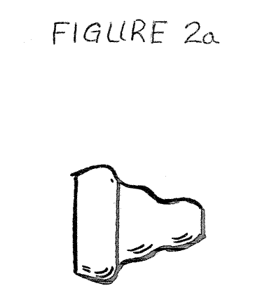

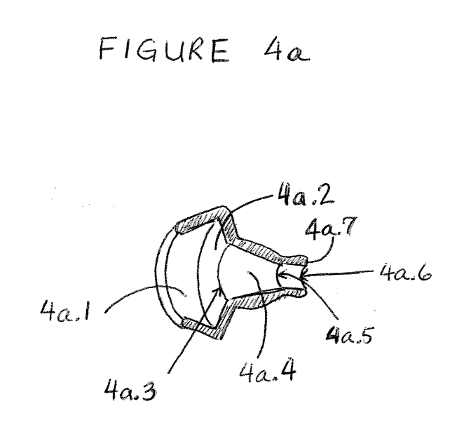

Referring to FIGS. 1, 2, 2a and 5 of the drawings, the bulbous ear phone called an ear bud FIG. 1 is inserted into the attachment FIG. 2 as depicted in FIG. 5. FIG. 2a shows the outside shape of the attachment. The attachment FIG. 2 at point 2.1 is particularly designed to firmly receive the ear bud and to tightly grip the rim 1.1 which circles around the outside edge of ear bud speaker and which also reaches around the ear bud speaker and grips the back of the rim 1.2 of the ear bud speaker.

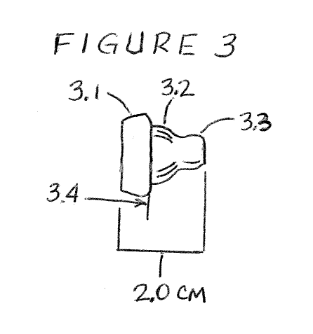

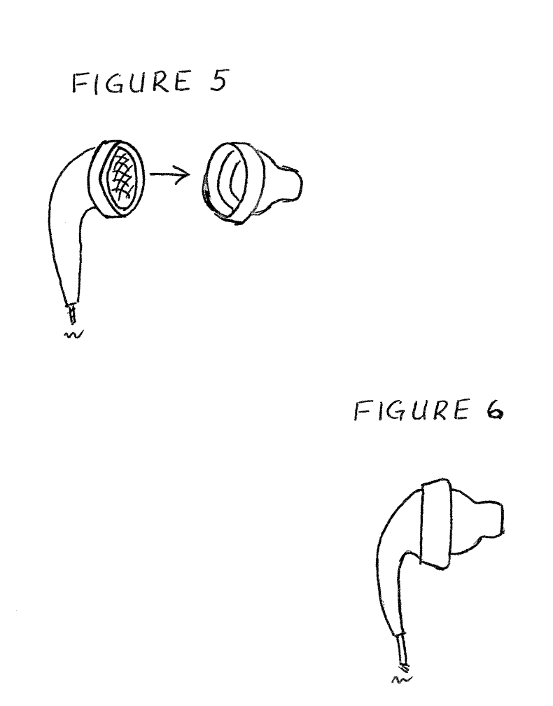

Referring now to FIGS. 1a, 3 and 6 of the drawings, the attachment encloses the entire speaker 1a.1 and directs the sound through the attachment. The said attachment is made of a soft flexible material that is durable and strong enough to hold on to and support the weight of both the ear bud and the supply cord. The attachment FIG. 3 provides a gradual transition in size from the largest end 3.1 which fits the contours of the ear bud, to the mid section 3.2 which is the transition section, to the smallest end 3.3 of the attachment that fits into the listener's ear. The smallest section of the attachment, 3.3 conforms to the outside edge of the ear canal which helps keep the entire ear bud and attachment FIG. 6 in place. Section 3.3 fits snug which helps block back ground noise.

The attachment is made of soft PVC vinyl which is a flexible material that is also very durable and strong enough to hold onto an ear bud, and support its weight as well as the weight of the supply cord. The material must be firm enough for a compression fit in the user's ear, and at the same time be soft enough for a comfortable fit and feel in the ear. The attachment is manufactured through an injection molding process. A core and a cavity are made from stainless steel. The core shapes the inside of the attachment and the cavity shapes the outside of the attachment. Together they form a pattern or die of the attachment. The soft PVC is heated and injected into the die, when the PVC cools the fully formed attachment is ejected from the die.

This following description refers to the outside of the attachment.

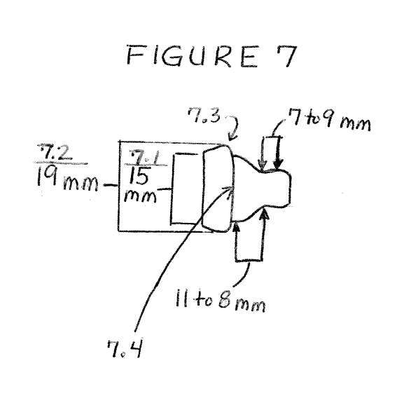

Referring now to FIGS. 1, 3, 4, 7 and 9 of the drawings and explaining the outside dimensions of the attachment. The flange, section 3.1 fits snuggly over the output end 1a.1 of the ear bud. Moving from left to right, the flange opening 7.1 measures 15 mm in diameter from the tip, and gradually flairs out to 19 mm in diameter at its widest point 7.2. The widest section of the flange then takes approximately a 40 degree angle 7.3 then transitions into the seat or butt plate 7.4. A depiction of the measurements can be seen in FIG. 7. The inside of the rim and seat measurements, dimensions and function will all be described in the next subdivision of the detailed description of the inside of the attachment. The flange 4a.1 is about 1 mm thick, and is stretchy and flexible. The flange has a universal design to accommodate many bulbous ear buds. The universal design to fit on many different ear buds is what makes the attachment unique in that most ear buds are of relative consistent shape and relative consistent size from 14 mm to 17 mm in diameter. The universal design allows the attachment to be used on round, near round or oval shaped ear buds. A smaller number of more customized ear buds are manufactured to function with specific attachments. The attachments are not universal and are specifically designed to fit and function only with their intended mate. The current invention/attachment is not interchangeable with that type of ear bud. The said flange is able to grip the rim 1.1 of an ear bud. The size of an ear bud can range in size from 14 mm to 17 mm in diameter. When the ear bud is inserted into the attachment moving in a line from left to right FIG. 3, point 3.4 is the stopping point where the face of the ear bud meets the seat or butt plate of the attachment. The flange 3.1 & 4a.1 and seat 3.4 seals tightly around the outside edge of the ear bud. The seat then directs the music or media into the mid section 3.2 of the attachment. Section 3.2 serves as the transition area and is shaped like a cone with rounded sides. Section 3.2 gradually decreases in size from approximately 11 mm to 8 mm FIG. 7 and allows for the larger area that contains the ear bud to be transitioned to a smaller size. A smooth transition is needed on the outside to accommodate the funnel shape which is on the inside. Section 3.3 is the smallest section and is approximately 7 to 9 mm FIG. 7 in diameter and is where the sound exits the attachment and enters the ear. Section 3.3 seals to the outside edge of the ear canal and helps to block out background noise. Section 3.3 is approximately 2 mm thick, is soft, flexible and conforms to the outside edge of the ear canal. As the material warms to the body temperature, the attachment becomes softer resulting in a better fit and increased comfort to the listener.

The following description refers to the inside of the attachment.

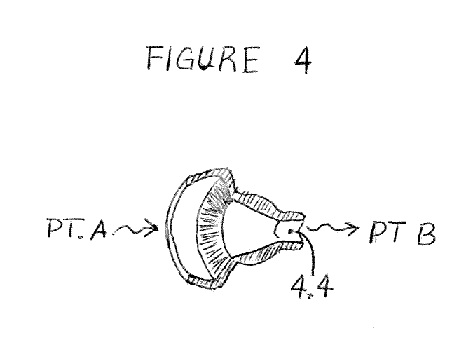

Referring now to FIGS. 1, (1a), 4, (4a) and 7, the inside of the flange 4a.1 is contoured to fit the curvatures of standard said ear bud FIG. 1. The flange has a universal design to accommodate many bulbous ear buds. The flange 4a.1 is approximately 1 mm thick. The receiving section of the attachment or (the flange opening) FIG. 7.1 is approximately 15 mm in diameter. The flange opening flares to approximately 19 mm in diameter 7.2. The widest section of the flange 7.2 then takes an approximately 40 degree angle 7.3 then transitions into the seat or butt plate 7.4. The flange 4a.1 reaches around and grips the outside circumference 1.1 and the back 1.2 of the ear bud. The inside circumference of the seat 4a.3 is the point of entrance where sound exits the ear bud speaker 1a.1 and enters into the attachment. The ability to fit many different brands and sizes of ear buds is what makes the attachment unique in that most ear buds are of relative consistent shape and are of relative consistent size, between 14 mm and 17 mm in diameter. The universal design allows the attachment to be used on round, near round or oval shaped ear buds as well. As the ear bud is inserted into the attachment, the seat 4a.2 is the stopping point where the face of the ear bud meets the seat. The seat is also depicted in FIGS. 3, 3.4. The exact media or sound input point is at 4a.3. From this point to 4a.6 the media output section, the sound is compressed in order for it to travel from the ear bud to the ear canal. The sound passes from left to right on a line from point A to point B, as shown in FIG. 4. The funnel 4a.4 is 9 mm in diameter 4a.3 at the large end, and 5mm in diameter 4a.5 the small end. The media exit outlet 4.4 is a constant 5 mm tunnel.

The seat 4a.2 seals tightly around the outside face of the ear bud 1a.1. The seat then directs the music into the funnel 4a.4 of the attachment. Because the flange 4a.1 and the seat 4a.2 seals around the edges of the front face of the ear bud, sound is directed into the funnel 4a.4, where it then travels to 4.4 (FIG. 4) and then into the ear. As the music or media travels from a larger space to a smaller space the music or media sound is increased relative to the area it is afforded. Because the music or media is now louder, the listener can turn the volume down using the volume control switch located on the media player. By turning down the volume less energy is needed to run the media player. As a result the power supply or batteries are now afforded a longer life. In other words, decreasing the volume increases the life of the battery or power source needed to run the media player. This is an advantage to the listener as fewer charges or batteries are needed, and an increase in listening time between charges. The tunnel exit walls 4a.7 are approximately 2 mm thick. The exit walls are just thick enough for a firm compression fit in the listener's ear and yet soft and flexible to conform to the listener's ear. As the listener's body's temperature warms the material, the said exit walls are such thickness, as the material warms up, the exit walls become softer and more flexible. The warmer they become the more comfortable they become. Further as the material conforms to the inside of the ear canal the more stable they become and stay in place.

FIG. 5, it can be seen that the ear bud gets inserted into the attachment.

FIG. 6, it can be seen that the two pieces now become one piece that function as a single device. The attachment can be removed for cleaning.

What is claimed is:

1. The attachment is a single piece of injected molded PVC vinyl or other suitable material and is shaped like a funnel with ridges, which can be attached to and easily removed from a standard spherical ear bud. The larger section is the “input” or receiving section of the attachment and fits completely around the “output” end of the of the ear bud. The ability to fit many brands of ear buds is what makes the attachment unique.

2. An attachment according to claim 1, is made from material that is designed to be soft and flexible yet rigid enough to keep ear buds snug and secure in the listener's ear, while supporting both the weight of the ear bud and the weight of the supply cord.

3. An attachment according to claim 1, wherein said attachment surrounds the face of the speaker, protects the micro-electronics contained inside the ear bud from cerumen (ear wax), sweat, and other contaminants. Over time, salt and other contaminants will damage the micro-electronics contained inside the ear bud.

4. An attachment according to claim 1, wherein said ear bud is inserted into the larger end of said attachment, the sound or media from said ear bud then travels through the funnel running from the larger end to the smaller end of the attachment. The rim and seat does not allow media to escape as it is forced through the funnel essentially increasing the volume relative to the space the media is afforded. Said another way, keeping the volume at the same level, but giving the media less space to travel through results in more media per volume of space. This increase in volume affords the listener the opportunity to turn down the volume on the main media unit.

5. An attachment according to claim 4, wherein reducing the volume of the media using the control switch on the media player allows the power source a longer life between charges or fewer batteries. Said differently, it takes less energy to play the media at lower volumes.

6. The gradual transition of the attachment from the large device to the small tunnel shape allows attachment to fit small, medium or large ear openings.

7. The attachment, which is shaped like a wedge, provides for a compression fit in the listener's ear and blunts background noise.

8. An attachment according to claim 7, wherein blocking background noise (sound isolation) allows the listener to turn the volume down which helps preserve long term hearing and reduces short term hearing fatigue. Normally the listener is forced to drown out back ground noise by turning up the volume.

9. The attachment provides comfort to the listeners as apposed to the hard plastic of the standard ear bud.

10. The attachment provides the listener an opportunity for a cleaner object to be placed in the listeners ear, wherein said ear buds can not be properly cleaned without the fear of damaging the micro-electronics contained inside the ear bud unit. The said attachment is easily removed and re-attached after being sterilized with alcohol or other mild cleansers suitable for sterilizing such an apparatus.
